(19) United States
(12) Patent Application Publication
(10) Pub. No.: US 2008/0226103 A1
(43) Pub. Date: Sep. 18, 2008

(54) Audio Data Processing Device for and a Method of Synchronized Audio Data Processing

(75) Inventor: Daniel Willem Schobben, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,511

(22) PCT Filed: Sep. 6, 2006
(86) PCT No.: PCT/IB2006/053127

§ 371 Date: Mar. 12, 2008

(30) Foreign Application Priority Data
Sep. 15, 2005 (EP) 05108504.1

(51) Int. Cl. H04R 5/033

(52) U.S. Cl. 381/309

(57) ABSTRACT

An audio data processing device (100), comprising a first audio data storage unit (101) and a first processor unit (102), wherein the first audio data storage unit (101) is adapted to store first audio data, wherein the first processor unit (102) is coupled to the first audio data storage unit (101) and is adapted to process the first audio data so that the first audio data is reproducible by a first audio reproduction unit (103), wherein the first processor unit (102) is adapted to be synchronized with a second processor unit (105) coupled to a second audio data storage unit (104), and the second processor unit (105) being adapted to process second audio data stored in the second audio data storage unit (104) so that the second audio data is reproducible by a second audio reproduction unit (106) synchronized to a reproduction of the first audio data by the first audio reproduction unit (104).

### FIELD OF THE INVENTION

The invention relates to an audio data processing device.

The invention further relates to a method of processing audio data.

Moreover, the invention relates to a program element.

Further, the invention relates to a computer-readable medium.

### BACKGROUND OF THE INVENTION

Audio playback devices become more and more important. Particularly, an increasing number of users buy portable audio/video players, powerful and intelligent cellular phones, and other portable entertainment equipment. For convenient use, such audio playback devices comprise in many cases earphones or headphones.

Known are headphones with 3D sound processing. In such a system, both left and right channels are processed in the same digital signal processor (DSP) unit or box.

Furthermore, full size headphones with integrated MP3 player are known. Wireless earpieces exist as well (for instance with a Bluetooth connection), allowing for streaming stereo content to two earpieces.

Also known are devices making a soothing sound to help a user sleep (for instance sound of the sea, wind, etc.). People suffering from tinnitus may hear a constant high-pitched sound that may particularly be apparent in a quite environment, for instance when such users are in bed.

US 2004/0141624 A1 discloses a system that comprises a pair of hearing aid devices, which hearing aid devices wirelessly receive signals from a stereo system via an induction loop under a pillow at bedtime. Recordings of high-frequency noise bands (water sounds), babble noise, traffic sounds and music have been used to mask tinnitus using this system.

U.S. Pat. No. 6,839,447 B2 discloses a wireless binaural hearing aid system that utilizes direct sequence spread spectrum technology to synchronize operation between individual hearing prostheses.

### OBJECT AND SUMMARY OF THE INVENTION

It is an object of the invention to enable audio playback with reasonable power consumption.

In order to achieve the object defined above, an audio data processing device, a method of processing audio data, a program element and a computer-readable medium according to the independent claims are provided.

According to an exemplary embodiment of the invention, an audio data processing device is provided, comprising a first audio data storage unit and a first processor unit, wherein the first audio data storage unit is adapted to store first audio data, wherein the first processor unit is coupled to the first audio data storage unit and is adapted to process the first audio data so that the first audio data is reproducible by a first audio reproduction unit, and wherein the first processor unit is adapted to be synchronized with a second processor unit coupled to a second audio data storage unit, and the second processor unit being adapted to process second audio data stored in the second audio data storage unit so that the second audio data is reproducible by a second audio reproduction unit synchronized to a reproduction of the first audio data by the first audio reproduction unit (particularly, “processing” may include just playing back audio or performing calculations or modifications before playing back the audio).

According to another exemplary embodiment of the invention, a method of processing audio data is provided, the method comprising processing, by means of a first processor unit, first audio data stored in a first audio data storage unit so that the first audio data is reproducible by a first audio reproduction unit, processing, by means of a second processor unit, second audio data stored in a second audio data storage unit so that the second audio data is reproducible by a second audio reproduction unit, and synchronizing the first processor unit with the second processor unit so that the second audio data is reproducible synchronized to a reproduction of the first audio data.

According to still another exemplary embodiment of the invention, a program element is provided, which, when being executed by a processor, is adapted to control or carry out a method of processing audio data having the above mentioned features.

According to yet another exemplary embodiment of the invention, a computer-readable medium is provided, in which a computer program is stored which, when being executed by a processor, is adapted to control or carry out a method of processing audio data having the above mentioned features.

The audio processing according to embodiments of the invention can be realized by a computer program, that is by software, or by using one or more special electronic optimization circuits, that is in hardware, or in hybrid form, that is by means of software components and hardware components.

According to an exemplary embodiment of the invention, an audio device may be provided having two parallel streams of audio data storage devices, processors and reproduction units, wherein audio data stored in the memory devices are processed by the connected processor and are reproduced by emitting acoustic waves by means of the reproduction devices. Therefore, two audio streams are processed in parallel using two separate audio storage devices in order that audio sound can be selectively adjusted to the requirements of a left ear and a right ear of a human listener. Furthermore, the provision of two separate audio content storage devices may make it dispensable to transmit, for instance wirelessly, audio data from a common audio content storage device to two loudspeakers, which provision may reduce the amount of energy needed for operating the system.

The audio data stored in the two memory devices may be stored redundantly, that is to say identical data may be stored in both memory devices. Alternatively, each of the memory devices may pre-store special audio data which are needed for supplying a respective human ear with music or other audio content.

Such a system may provide a high quality of audio processing and reproduction, a fast audio reproduction and a low power operation of the audio data processing device, since the coupling of the memory devices to the processors in two individual paths may be operated with a quite low amount of electrical energy.

Synchronization may be performed from time to time, for instance regularly after expiry of a waiting time (of, for instance, some hours). Additionally or alternatively, synchronization may be performed when special events occur, for instance after a user of an audio playback device has utilized or operated a user interface (for instance has operated a “stop” button or a “start” button). In such a scenario, refreshment of the synchronization may be appropriate.

By synchronizing the timing of the playback of the two audio channels defined by the two audio storage devices, a delay between sound emitted by a left ear loudspeaker and sound emitted by a right ear loudspeaker may be avoided or reduced. This may significantly improve the quality of the audio playback.

By implementing two separate audio storage devices, it may be avoided that data of a single audio storage device has to be transmitted wirelessly to one of two loudspeakers. In contrast to such a costly and power consuming scenario, the necessary power for operating the system according to an embodiment of the invention may be significantly lower which may be appropriate for a portable or battery operated audio device. While prices for solid-state memories are falling rapidly and MP3 decoding can be done at low power consumption (for instance well below 0.5 mW), wireless transmission of audio may require heavy compression, a limited bandwidth and considerable power consumption.

Even if a wireless transmission should be possible in the prior art (which may require large batteries), some sound processing that requires access to both left and right channels is not easily possible in that player using a low bandwidth and hence low power such as adaptation of the sound to the acoustics of the earpieces and head tracking for 3D sound image stabilization.

MP3 or similar decompression of the audio, which will be stored or transmitted in a compressed format, may be advantageous.

According to an exemplary embodiment, two earpieces are equipped with solid-state audio players for stereo playback, wherein the two earpieces may be synchronized using a control signal, for instance transmitted by a wireless transmission channel. Thus, a synchronized wireless binaural MP3 earphone system may be provided. Thus, earpieces may be equipped with a solid-state audio player while the synchronization between left and right ear may be done wirelessly. This may be performed by sending a control signal which may require only very little power. The synchronization may be within “one sample accuracy”, which may be easily obtained by time stamping a packet, sending it over to the other side, time stamping it there and sending it back. This together with assuming symmetric traveling times and repeating for increased accuracy may be sufficient to obtain a sufficiently high accuracy.

Hence, according to an exemplary embodiment, earpieces with a solid-state audio player (for instance an MP3 player) may be provided, while the synchronization between left and right ear may be done wirelessly. The synchronization signal may be generated by the earpieces or by a remote control.

Each earpiece may only store its own audio channel. Alternatively, in both earpieces both channels may be stored allowing for an MP3 file upload to the earpieces as well as 3D sound manipulation.

The earpieces may be hearing aids. Solid-State Audio (SSA) may be activated in quiet environments for tinnitus treatment. Particularly, the contribution of the SSA may be made dependent on the acoustic environment. The SSA may play stationary background noise.

Furthermore, the earpieces may have an interface to a docking station for charging and audio synchronization.

Exemplary fields of application are Bluetooth earpieces, wireless earphones and hearing aids.

According to an exemplary embodiment, a synchronized wireless binaural MP3 earphone system may be provided. In headphones, independently storing and processing/decoding of each channel audio, by audio players in each earpiece, may thus process the stereo audio. Furthermore, synchronization between earphones may be realized wirelessly, for instance sending a time-stamped packet from one earphone to another earphone and returning the packet time-stamped by the other earphone.

A device for processing audio data according to an exemplary embodiment may comprise storage means adapted to store first audio data and rendering means adapted for rendering said first audio data and outputting a first rendered audio signal. Synchronization means may be adapted to receive synchronization signals for synchronizing said rendering of the first audio data in relation to rendering of second audio data of a second device for processing audio data.

The storage means may be adapted to store audio data comprising multiple audio channels. The device may further comprise selection means adapted to select the first audio data among one of the multiple audio channels stored. The first audio signal may be a left channel signal (for a left ear of a human user) and the second audio signal may be a right channel signal (for a right ear of a human user) of a music track.

Hence, the comfort of wireless listening experience may be combined with simultaneously obtainable reduced power consumption.

According to an exemplary embodiment, the left side and right side of a headset may be free of any physical connection. Furthermore, it may be possible to wirelessly synchronize the earpieces to ensure that microphone signals are sampled synchronously at both sides. In this context, it is possible to store audio redundantly at both sides for MP3 playback.

Particularly, it is referred to synchronously capturing microphone signal from the earpieces (a binaural recording or for communication purposes).

One exemplary aspect of the invention can be seen in the fact that both earpieces may have the audio content locally stored. It is known that current headphones with an MP3 player have only one memory with audio data stored therein and one sound processor that connects with wires to the two earpieces in the headphones.

According to an exemplary embodiment, it is possible to equip earpieces of a (stereo) headphone with 3D sound processing units computing left and right audio signals separately from each other in each unit. The earpieces can be configured to act as left or as a right earpiece. The audio signals may be synchronized (concerning playback timing, playback amplitude, equalization and/or reverberation) between each unit.

No separate (MP3) audio player is required. Furthermore, some sound processing, such as adaptation of the sound to the acoustics of the earpieces and head tracking for 3D sound image stabilization, may be enabled by an embodiment of the invention, which has not easily been possible in a separate audio player.

With respect to an embodiment of processing 3D audio, such a processing may be based on HRTFs (Head Related Transfer Functions). HRTFs may be denoted as sets of mathematical transformations that can be applied to a (mono) sound signal. The resulting left and right signals may be the same as the signals that someone perceives when listening to a sound that is coming from a location in real life 3D space. HRTFs may contain the information that is necessary to simulate a realistic sound space. Once the HRTF of a generic person is captured, it can be used to create sound for a significant percentage of the population (since most peoples' heads and ears and therefore their HRTFs are similar enough for the filters to be interchangeable).

The processing may be split up to the two earphones. Both earpieces receive stereo (or multi-channel) audio and process with HRTFs to obtain left or right ear signals. This may be reasonable as computing everything on one side and transmitting it to the other side may require more power consumption. For instance, each of the players may then store a HRTF database.

According to an exemplary embodiment, an MP3 player is built twice, one per earpiece. A user may dock then both in a USB cradle to facilitate downloading new songs. MP3 decoding may be performed at a low power requirement of, for instance 0.5 mW. In contrast to this, Bluetooth may take around 100 mW for audio streaming and may introduce unknown delays in an undesirable manner.

The earpieces could both receive a DAB radio broadcast in stereo and filter with HRTFs. Furthermore, both earpieces can sense head rotation independently and adapt the 3D audio accordingly (alternatively, a head rotation signal should be transmitted to an MP3 player which should render the sound which requires a two-way radio). It is possible to use a separate head rotation sensor for each earpiece, or a common head rotation sensor.

The audio data storage units may be memory devices like hard disks or other memory devices on which audio content, for instance music or other sound, can be stored.

The processor units may be microprocessors or CPUs (central processing units), which may be manufactured as integrated circuits, for instance in silicon technology.

The first audio data and the second audio data may be different audio channels of a music or any other audio piece, or may be complete audio items.

The audio reproduction units may be loudspeakers, earphones, headphones, etc.

Next, further exemplary embodiments of the invention will be described.

In the following, exemplary embodiments of the audio data processing device will be described. However, these embodiments also apply for the method of processing audio data, for the program element and for the computer-readable medium.

The first audio data storage unit and the second audio data storage unit may be provided as physically separate data storage units. Thus, the two audio data storage units may be different memory devices working independently from one another, each assigned to a different path of the audio processing system. Therefore, the audio processing may be performed independently in the two channels, with the exception of the synchronization that may couple the functionality of the two storage devices.

The first processor unit may comprise a first synchronization interface. The second processor unit may comprise a second synchronization interface. The synchronization may be performed via the first synchronization interface and via the second synchronization interface. Thus, two interfaces may be provided at the processor units (DSP) which allow processing algorithms or operation parameters of the processor units to be synchronized to one another, so as to enable that sound emitted towards two ears of a human user is synchronized, for instance in time and/or amplitude.

The synchronization interfaces may perform the synchronization in a wired manner or in a wireless manner. For instance, the synchronization interfaces may be connected with a wired (ohmic) connection to one another or to/via a further synchronization unit. Then, the synchronization may be performed via the exchange of electric signals transported via the wired connection. Also optical transmission media are possible, for instance using glass fibers or the like. Alternatively, the transmission of synchronization signals may be carried out in a wireless manner, for instance via the exchange of electromagnetic waves propagating between the different synchronization interfaces or between a synchronization interface and a separate synchronization unit. Such electromagnetic waves may be in the radio frequency domain, in the optical domain, in the infrared domain, or the like. For instance, a Bluetooth communication is possible in this context.

The synchronization may be performed via a transmission of a synchronization control signal between the first synchronization interface and the second synchronization interface. Such a control signal may include the information concerning a time at which a particular part of an audio item is replayed by one of the reproduction units. This information provided to the other processing unit may allow synchronizing the replay of the audio content by the two reproduction units, under the control of the two processor units, that is to say the first and second processor unit.

Particularly, the synchronization may be performed via a transmission of a time-stamped packet from the first synchronization interface to the second synchronization interface, and by returning the time-stamped packet from the second synchronization interface to the first synchronization interface. Such a time-stamped packet may include all the information necessary for the two processor units to establish a synchronization of the audio reproduction.

The first processor unit may comprise a first synchronization interface, the second processor unit may comprise a second synchronization interface, and the synchronization may be performed by means of a communication between the first synchronization interface and the second synchronization interface. In other words, it is possible that the two processor units communicate directly with one another, without any further element connected in between, so that a direct communication for synchronization between the processor units may be obtained.

Alternatively, a separate synchronization unit may be provided in the audio data processing device, which is adapted to perform the synchronization. Both synchronization interfaces of the two processor units are coupled to the synchronization unit which mediates the synchronization performance. Thus, no direct communication path between the two processor units is necessary, and a separate synchronization unit may care about the synchronization. For instance, the synchronization unit may communicate with each of the processor units separately and may process the data exchanged with the processor units so as to obtain synchronization. Alternatively, the synchronization may simply convey signals originating from one of the synchronization interfaces to the other one of the synchronization interfaces.

The communication between the synchronization unit and any one of the processor units may be performed in a wired manner or in a wireless manner, similarly as the above-described communication between the synchronization interfaces of the processor units.

The synchronization unit may be a remote control. Such a remote control may be automatically controlled, or may be controlled or operated by a user.

The first audio data may be processed so as to be reproducible by the first audio reproduction unit to be perceived by a first ear of a human being. Furthermore, the second audio data may be processed so as to be reproducible by the second audio reproduction unit to be perceived by the second ear of the human being. Thus, the processing of the audio data may be realized in such a manner that the content perceivable by the two ears are adjusted.

The first audio data stored in the first audio data storage unit may be at least partially identical to the second audio data stored in the second audio data storage unit (that is may be stored redundantly). They may also be completely identical. Thus, two different decoupled paths of audio processing/storage may be provided, which may allow operating the two channels in an autarkic manner. However, the two paths may be synchronized, for instance in the time domain, in the frequency domain, in the intensity domain, etc.

Alternatively, the data stored in the different audio data storage units may differ, partially or completely. For instance, the audio data stored in the two storage devices may relate to two different audio channels, the one channel for the left ear, and the other channel for the right ear.

The first processor unit, the first audio data storage unit and the first audio reproduction unit may be part of a first earpiece or of a first headphone. Similarly, the second processor unit, the second audio data storage unit and the second audio reproduction unit may be part of a second earpiece or of a second headphone. Particularly, all components or a part of the components needed for audio data processing may be integrated in an earphone or in a headset. This may make it possible to manufacture a small dimensioned audio reproduction system with proper audio reproduction quality, including features like synchronization in the time domain and generation of 3D audio effects, or the like.

The audio data processing device may comprise an audio amplitude detection unit adapted to detect an audio amplitude present in an environment of the audio data processing device and adapted to initiate or trigger audio data reproduction by the first audio reproduction unit and/or by the second audio reproduction unit when the detected audio amplitude is below a predetermined threshold value, that is when the environment is sufficiently silent. For instance, users suffering from tinnitus may use the audio data processing device having such a feature. In a silent or quiet environment and when the tinnitus-suffering user perceives a disturbing high-frequency ambient noise, the audio amplitude detection unit may detect this quiet environment. In case that the environment is very quiet and the predetermined threshold value of the intensity of the audio signals originating from the environment is not exceeded, the audio amplitude detection unit may provide this information to the processing units, which, in turn, may start reproduction of the audio content so that the tinnitus-suffering person automatically hears a background noise that may provide relief to the tinnitus-suffering person, for instance in bed before sleeping.

The audio amplitude detection unit may be adapted to initiate audio data reproduction with a reproduction-amplitude based on the detected audio amplitude. For instance, the louder the environment, the louder the audio reproduction.

The audio amplitude detection unit may be adapted to initiate audio data reproduction with audio content related to stationary background noise. Such stationary background noise may be ocean sound, wind, the noise of a mountain stream, or the like.

The audio data processing device may comprise an interface to a docking station to be detachably connectable with at least a part of the components of the audio data processing device so as to supply the audio data processing device with energy and/or with audio data and/or to perform the synchronization. Thus, when the audio data processing device is positioned to be received in the docking station, an accumulator or a battery of the audio data processing device may be (re-)loaded so that electrical energy is provided to the system. Additionally or alternatively, when the audio data processing device is in the docking station, the left and the right ear channel audio components may be synchronized. Furthermore, when the device is located on the docking station, music or other audio content may be (automatically or defined by a user) downloaded from the docking station to the two memory devices, for instance for updating the data stored on the memory devices.

The first audio data storage unit may be adapted to store audio data related to multiple audio channels, and the first processor unit may be adapted to select the first audio data among the multiple audio data channels for reproduction by the first audio reproduction unit. Therefore, a respective audio path of the audio data processing device may choose an appropriate one of a plurality of audio channels, for instance to provide the human listener with a three-dimensional acoustic experience. Also the second audio data storage unit may be adapted to store audio data related to multiple audio channels, and the second processor unit may be adapted to select the second audio data among the multiple audio channels for reproduction by the second audio reproduction unit.

The first processor unit may be adapted to process the first audio data based on a Head Related Transfer Function (HRTF) filtering. Also the second processor unit may be adapted to process the second audio data based on a Head Related Transfer Function filtering. Thus, when audio signals are provided at an input, the Head Related Transfer Function filtering that may be based on a HRTF database (stored in the processor units), may provide the human listener with a three-dimensional acoustical experience.

The audio data processing device may comprise a head rotation detection unit adapted to detect a motion of the head of a human being utilizing the audio data processing device and adapted to control the first processor unit and/or the second processor unit based on head rotation information detected by the head rotation detection unit. For instance, when a human user moves her or his head, this motion may be recognized by the head rotation detection unit, and this information may be used for controlling, regulating or adjusting the reproduction parameters by the processor units, and may be used for synchronizing these audio data.

The device for processing audio data may be realized as at least one of the group consisting of headphones, earphones, a hearing aid, a portable audio player, a portable video player, a head mounted display, a mobile phone comprising earphones or headphones, a medical communication system, a body-worn device, a DVD player, a CD player, a harddisk-based media player, an internet radio device, a public entertainment device, and an MP3 player.

However, although the system according to embodiments of the invention primarily intends to improve the quality of sound or audio data, it is also possible to apply the system for a combination of audio data and visual data. For instance, an embodiment of the invention may be implemented in audiovisual applications like a portable video player in which a headset or an earset are used.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows an audio data processing device according to an exemplary embodiment of the invention providing wired synchronization,

FIG. 2 shows an audio data processing device according to an exemplary embodiment of the invention providing wired synchronization by means of a synchronization unit,

FIG. 3 shows an audio data processing device according to an exemplary embodiment of the invention providing wireless synchronization,

FIG. 4 shows an audio data processing device according to an exemplary embodiment of the invention providing wireless synchronization by means of a synchronization unit,

FIG. 5 shows an audio data processing device according to an exemplary embodiment of the invention adapted as a hearing aid,

FIG. 6 shows an audio data processing device according to an exemplary embodiment of the invention providing wireless synchronization and amplitude detection,

FIG. 7 shows an audio data processing device according to an exemplary embodiment of the invention providing wireless synchronization and head rotation detection,

FIG. 8 shows an audio data processing device according to an exemplary embodiment of the invention in a detailed view.

### DESCRIPTION OF EMBODIMENTS

The illustration in the drawing is schematically. In different drawings, similar or identical elements are provided with the same reference signs.

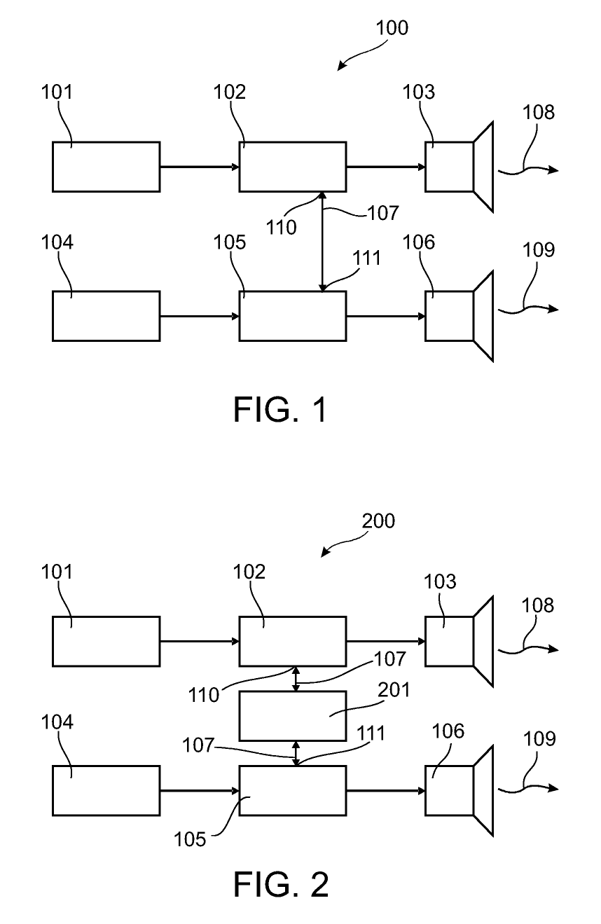

In the following, referring to FIG. 1, an audio data processing device 100 according to an exemplary embodiment will be described.

The audio data processing device 100 comprises a first storage device 101, a first microprocessor 102, a first loudspeaker 103, wherein components 101 to 103 form a first audio processing channel.

Furthermore, the audio data processing device 100 comprises a second storage device 104, a second microprocessor 105 and a second loudspeaker 106 forming a second audio processing path.

The first storage device 101 in the present case is a harddisk that stores audio content, for instance MP3 files. Also the second storage device 104 is a harddisk for storing audio items like music pieces or the like. Particularly, first audio data items are stored in the first storage device 101, and second audio items are stored in the second storage device 104.

The first microprocessor 102 is coupled to the first storage device 101 and is adapted to process the first audio data items so that the first audio data items may be reproduced by the first loudspeaker 103. Similarly, the second microprocessor 105 is coupled to the second memory device 104 and is adapted to process the second audio data items so that the second audio data items are reproducible by the second loudspeaker 106. “Reproduction” in the context means that the reproduction units 103, 106 generate acoustic waves in accordance with the audio content to be reproduced so that the generated acoustic waves are perceivable by a human being.

Furthermore, a wired synchronization connection 107 is provided to connect the first microprocessor 102 to the second microprocessor 105. By the wired synchronization connection 107, the timing of the playback of the data by the first loudspeaker 103 and by the second loudspeaker 106 may be synchronized. Thus, the audio data, which is emitted in the form of acoustic waves 108, 109, may be guided to two different ears of a human user. Particularly, the acoustic waves 108 are transferred to an ear canal of a left ear of a human user, and the acoustic waves 109 are guided to an ear canal of a right ear of a human user.

As can be seen in FIG. 1, the first storage device 101 and the second storage device 104 are provided as two physically separated devices. Particularly, according to the described embodiment, both devices do not share access to a common audio database. In contrast to this, respective audio data are locally stored in the devices 101, 104.

Pseudo-wired synchronization might be reasonable by using the conductivity of the skin to exchange information between the ear-pieces through two pairs of electrodes. This communication may be rather noisy and therefore has a limited bandwidth, but it would be well suited to transmit synchronized information.

Since, according to the described embodiment, the first audio data items stored in the first storage device 101 and the second audio data items stored in the second storage device 104 are identical, these data are stored redundantly there. By means of HRTF filters implemented in the microprocessors 102, 105, the audio data may be modified or conditioned in such a manner that a user listening to the acoustic waves 108, 109 has a three-dimensional acoustic experience.

As can further be seen in FIG. 1, the wired synchronization connection 107 is connected between a first synchronization interface 110 of the first processor unit 102 and a second synchronization interface 111 of the second processor 105. For synchronizing the playback of the audio content of the loudspeakers 103, 106, synchronization control signals may be exchanged via the bidirectional communication path established by means of the wired synchronization connection 107.

It is possible that the wired connection is available only when the user holds them against each other prior to using them, or when they are in a carrying pouch.

For instance, a time-stamped packet may be transmitted from the first synchronization interface 110 of the first microprocessor 102 via the wired synchronization connection 107 to the second synchronization interface 111 of the second microprocessor 105. Furthermore, a time-stamped packet may be returned from the second synchronization interface 111 of the second microprocessor 105 via the wired synchronization connection 107 back to the first synchronization interface 110 of the first microprocessor 102.

The time stamping may be advantageous for wireless communication for which the propagation delay is unknown.

The audio data processing device 100 is a portable audio player.

In the following, referring to FIG. 2, an audio data processing device 200 according to an exemplary embodiment will be described.

The audio data processing device 200 differs from the audio data processing device 100 mainly in that a synchronization block 201 is connected within the wired synchronization connection 107 so as to serve as an intermediate processor element for synchronizing the data processing of the first microprocessor 102 and of the second microprocessor 105. Again, the synchronization block 201 is capable of bidirectionally communicating in a wired manner with the microprocessors 102, 105. Artificial intelligence and/or computational resources may be included in the synchronization block 201 so that the synchronization block 201 may perform centrally any synchronization computation necessary. By taking this measure, the audio data processing algorithms of the microprocessors 102, 105 are not disturbed, and the synchronization information can be provided in a pre-processed manner to both microprocessors 102, 105.

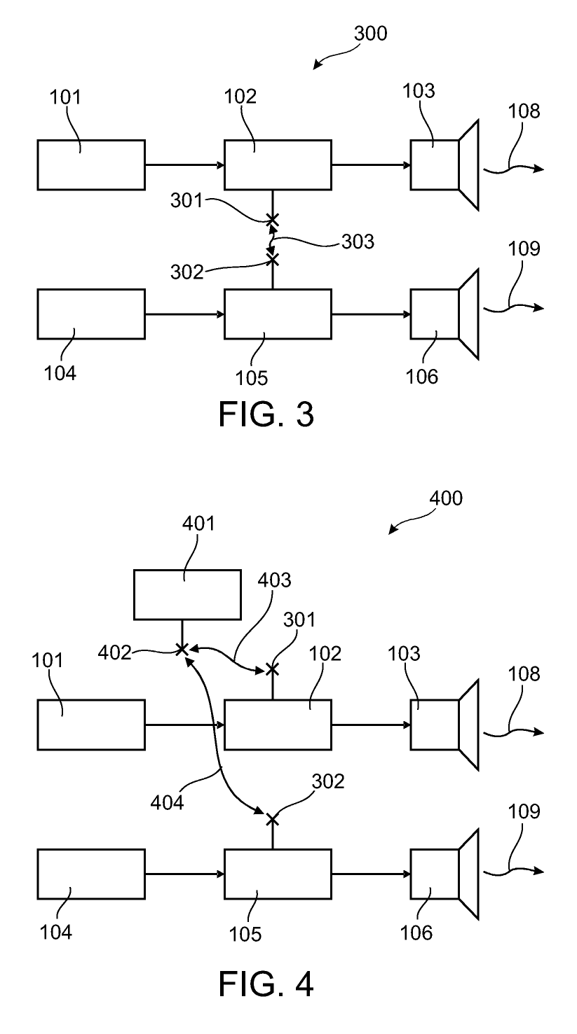

In the following, referring to FIG. 3, an audio data processing device 300 according to an exemplary embodiment will be described.

The audio data processing device 300 differs from the audio data processing device 100 in that a first synchronization interface 301 of the first microprocessor 102 is provided as a wireless synchronization interface. Also, a second synchronization interface 302 of the second microprocessor 105 is realized to enable a wireless communication with the first synchronization interface 301. Therefore, for synchronizing the data processing and reproduction of the microprocessors 102 and 105, wireless synchronization signals 303 may be directly exchanged between the microprocessors 102, 105, in the form of electromagnetic radiation (for instance in the radio frequency domain) containing synchronization signals.

In the following, referring to FIG. 4, an audio data processing device 400 according to an exemplary embodiment will be described.

The audio data processing device 400 differs from the audio data processing device 300 in that a remote control unit 401 is provided as an intermediate synchronization signal pre-processing unit. The remote control 401 comprises a third synchronization interface 402 adapted for wireless communication with any of the first or second synchronization interfaces 301, 302. For example, a wireless synchronization signal 403 can be exchanged between the third synchronization interface 402 and the first synchronization interface 301. In a similar manner, the wireless synchronization signal 404 may be exchanged between the third synchronization interface 402 and the second synchronization interface 302. In the present case a user controls the remote control 401. Alternatively, the remote control 401 may be operated separately, and may be stored or kept separately from the remaining components of the audio data processing device 400.

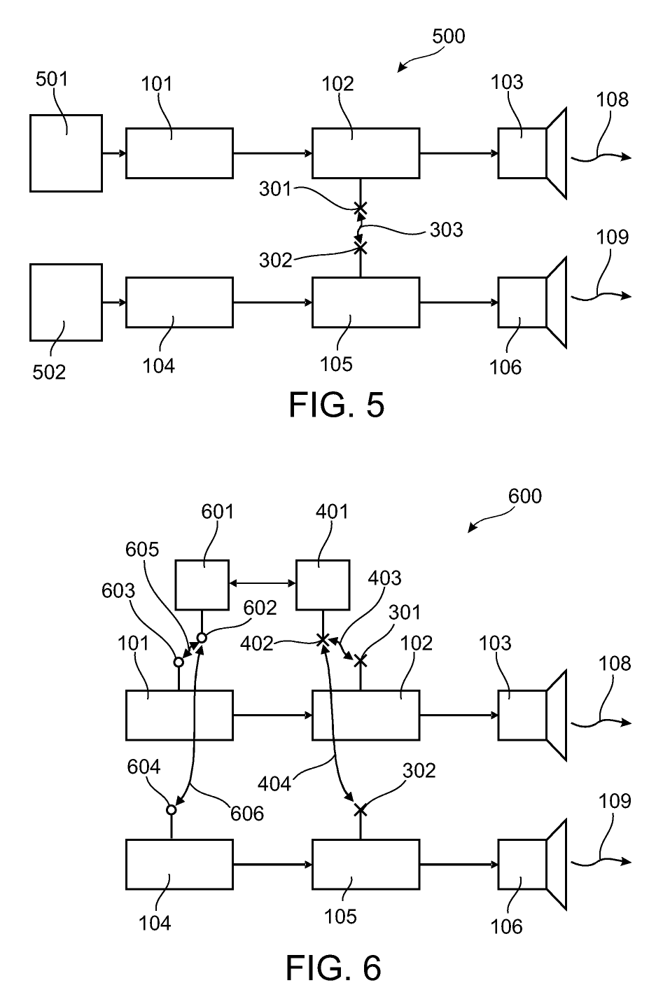

In the following, referring to FIG. 5, an audio data processing device 500 according to an exemplary embodiment will be described.

The audio data processing device 500 is adapted as a hearing aid.

The hearing aid 500 comprises a first microphone 501 adapted to detect audio signals from the environment, at a position close to a left ear of a human. Furthermore, a second microphone 502 is adapted to detect audio signals from the environment, at a position close to a right ear of the human. The first microphone 501 is coupled with the first memory device 101 to store audio content received by the first microphone 501. In a similar manner, the second microphone 502 is coupled to the second memory device 104 so as to supply the captured audio signals to the memory unit 104 for storage. In the following path, the audio content stored in the storage units 101, 104 is processed by the microcontrollers 102, 105 which are communicatively coupled in a wireless manner so as to wirelessly exchange synchronization signals 303, for synchronizing the playback.

Synchronization may also be done on acoustic signals in this case, e.g. by clapping hands to start playing a song.

In the following, referring to FIG. 6, an audio data processing device 600 according to an exemplary embodiment will be described.

The audio data processing device 600 differs from the audio data processing device 400 in that an audio amplitude detection sensor 601 is provided, which amplitude detection sensor 601 is adapted to detect an audio amplitude present in an environment of the audio data processing device 600 and is adapted to start audio data reproduction by the first loudspeaker 103 and by the second loudspeaker 106 when the detected audio amplitude is below a threshold value, indicating a silent environment.

When a user of the data processing device 600 suffering from tinnitus uses the audio data processing device 600, it may happen that the environment becomes very quiet (for instance in the bed at night). Then, the tinnitus sound is particularly disturbing for the user. When the audio amplitude detection sensor 601 detects that the noise in the environment is very silent, then, an initiating signal 605 may be sent from the audio amplitude detection sensor 601 via a first initiating signal interface 602 of the audio amplitude detection sensor 601 to a second initiating signal interface 603 of the first memory device 101, and an initiating signal 606 may be sent from the first initiating signal interface 602 to a third initiating signal interface 604 of the second memory device 104. Thus, these signals 605, 606 may initiate an audio data item transfer from the memory devices 101, 104 to the processors 102, 105 so that the loudspeakers 103, 106 may emit a stationary background noise (for instance ocean sound). The tinnitus-suffering user perceives this background noise so that the tinnitus signal is not perceived to be very much disturbing for the user.

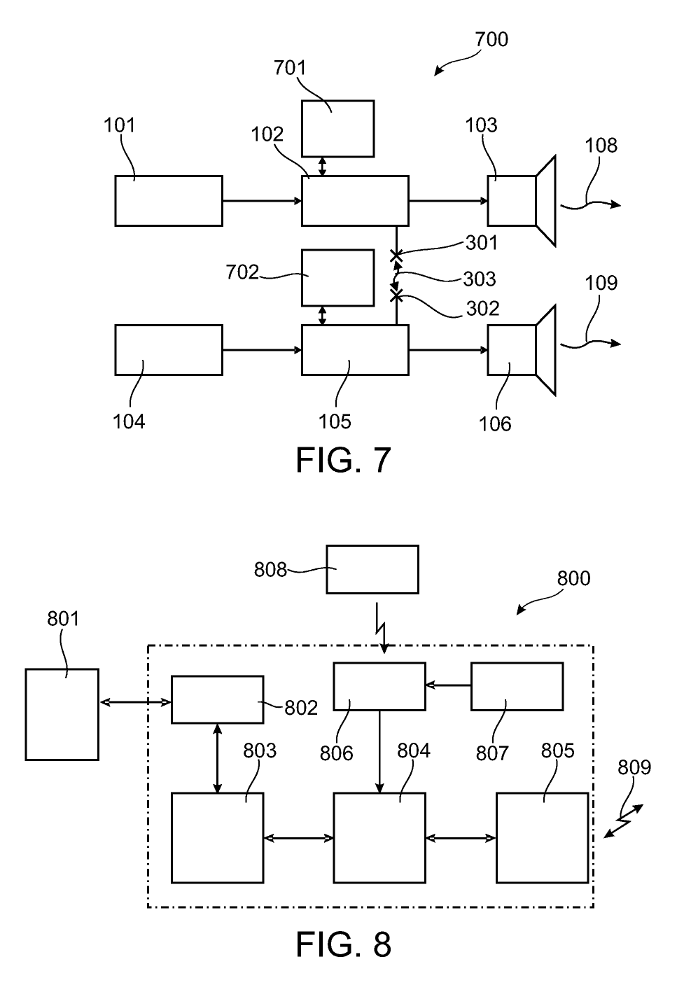

In the following, referring to FIG. 7, an audio data processing device 700 according to an exemplary embodiment of the invention will be described.

The audio data processing device 700 differs from the audio data processing device 300 in that a first head rotation detector 701 is provided which is coupled to the first microprocessor 102. Furthermore, a second head rotation detector 702 is provided which is coupled to the second microprocessor 105. The first and second head rotation detectors 701, 702 detect a head rotation of a human user carrying the earpieces 700. Furthermore, the signals detected by the head rotation detectors 701, 702 (which may be two separate components or which may be combined to be a single common component) are provided to the microprocessors 102, 105 so as to enable the microprocessors 102, 105 to recognize that the human user has moved his head. In such a scenario, the microprocessors 102, 105 may decide that it might be appropriate to adjust the audio properties of the signals replayed by the loudspeakers 103, 106 to achieve an improved audio quality.

In the following, referring to FIG. 8, an audio data processing device 800 according to an exemplary embodiment of the invention will be described.

The audio data processing device 800 comprises a storage database 801 for storing audio data items. The storage database 801 is coupled with an update interface 802 adapted to receive audio data from the storage database 801, which receive audio data may be stored in a storage unit 803 of the audio data processing device 800. The storage unit 803 is coupled to a rendering unit 804 adapted to process audio data signals stored in the storage unit 804. The rendering unit 804 is coupled to a synchronization unit 805 that synchronizes left and right ear audio data based on synchronization signals 809 transmitted in a wireless manner.

Furthermore, by means of a remote control 808, a remote control signal may be wirelessly transmitted to a user interface 806. Alternatively, interface 806 can also be operated by means of buttons 807 provided on or in the device 800. The user interface 806 provides a control signal to the rendering unit 804 so that the reproduction of the data is controlled based on such control signals.

The device for processing audio data 100 thus comprises the storage means 803 for storing audio data and the rendering means 804 for rendering the audio data and outputting rendered audio signal ready for reproduction by a loudspeaker (not shown). The synchronization unit 805 is adapted to receive synchronization signals 809 for synchronizing the audio data rendered for a left earpiece in relation to rendering audio data for a right earpiece.

The storage means 803 store audio data comprising multiple audio channels. The device 800 further comprises selection means 806 to 808 to select the audio data to be reproduced among one of the multiple audio channels stored. A first audio signal may be a left channel signal (for a left ear of a human user) and a second audio signal may be a right channel signal (for a right ear of a human user) of a music track.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. An audio data processing device (100), comprising
a first audio data storage unit (101); and
a first processor unit (102);
wherein the first audio data storage unit (101) is adapted to store first audio data representing a first audio signal;
wherein the first processor unit (102) is coupled to the first audio data storage unit (101) and is adapted to process the first audio data so that the first audio data is reproducible by a first audio reproduction unit (103);
wherein the first processor unit (102) is adapted to be time synchronized with a second processor unit (105) coupled to a second audio data storage unit (104), and the second processor unit (105) being adapted to process second audio data representing a second audio signal and stored in the second audio data storage unit (104) so that the second audio data is reproducible by a second audio reproduction unit (106) time synchronized to a reproduction of the first audio data by the first audio reproduction unit (104).

2. The audio data processing device (100) according to claim 1,
comprising the first audio reproduction unit (103).

3. The audio data processing device (100) according to claim 1,
comprising the second processor unit (105), the second audio data storage unit (104) and/or the second audio reproduction unit (106).

4. The audio data processing device (100) according to claim 1,
wherein the first audio data storage unit (101) and the second audio data storage unit (104) are provided as physically separate devices.

5. The audio data processing device (100) according to claim 1,
wherein the first processor unit (102) comprises a first synchronization interface (110), wherein the second processor unit (105) comprises a second synchronization interface (111), wherein the time synchronization is performed via the first synchronization interface (110) and via the second synchronization interface (111).

6. The audio data processing device (100) according to claim 5,
wherein the time synchronization is performed via the first synchronization interface (110) and via the second synchronization interface (111) in a wired manner or in a wireless manner.

7. The audio data processing device (300) according to claim 5,
wherein the time synchronization is performed via a transmission of a synchronization control signal (303) between the first synchronization interface (301) and the second synchronization interface (302).

8. The audio data processing device (300) according to claim 5,
wherein the time synchronization is performed via a transmission of a time-stamped packet from the first synchronization interface (301) to the second synchronization interface (302) and by returning the time-stamped packet from the second synchronization interface (302) to the first synchronization interface (301).

9. The audio data processing device (100) according to claim 5,
wherein the time synchronization is performed by means of a communication between the first synchronization interface (110) and the second synchronization interface (111).

10. The audio data processing device (200) according to claim 5,
comprising a synchronization unit (201) adapted to perform the time synchronization, wherein the first synchronization interface (110) is coupled to the synchronization unit (201), wherein the second synchronization interface (111) is coupled to the synchronization unit (201).

11. The audio data processing device (200) according to claim 10,
wherein the first synchronization interface (110) is coupled to the synchronization unit (201) to communicate in a wired manner or in a wireless manner, wherein the second synchronization interface (111) is coupled to the synchronization unit (201) to communicate in a wired manner or in a wireless manner.

12. The audio data processing device (400) according to claim 10,
wherein the synchronization unit is a remote control (401).

13. The audio data processing device (100) according to claim 1,
wherein the first audio data is processed so as to be reproducible by the first audio reproduction unit (103) to be perceived by a first ear of a human being.

14. The audio data processing device (100) according to claim 1,
wherein the second audio data is processed so as to be reproducible by the second audio reproduction unit (106) to be perceived by a second ear of a human being.

15. The audio data processing device (100) according to claim 1,
wherein the first audio data stored in the first audio data storage unit (101) is at least partially identical to the second audio data stored in the second audio data storage unit (104).

16. The audio data processing device (100) according to claim 1,
wherein the first audio data stored in the first audio data storage unit (101) is at least partially different from the second audio data stored in the second audio data storage unit (104).

17. The audio data processing device (100) according to claim 1,
wherein the first processor unit (102), the first audio data storage unit (101) and the first audio reproduction unit (103) are part of a first earpiece or of a first headphone.

18. The audio data processing device (100) according to claim 1,
wherein the second processor unit (105), the second audio data storage unit (104) and the second audio reproduction unit (106) are part of a second earpiece or of a second headphone.

19. The audio data processing device (600) according to claim 1,
comprising an audio amplitude detection unit (601) adapted to detect an audio amplitude of an environment of the audio data processing device (600) and adapted to initiate audio data reproduction by the first audio reproduction unit (103) and/or by the second audio reproduction unit (106) in case that the detected audio amplitude is below a predetermined threshold value.

20. The audio data processing device (600) according to claim 19,
wherein the audio amplitude detection unit (601) is adapted to initiate audio data reproduction with a reproduction amplitude determined based on the detected audio amplitude.

21. The audio data processing device (600) according to claim 19,
wherein the audio amplitude detection unit (601) is adapted to initiate audio data reproduction with audio content related to stationary background noise.

22. The audio data processing device (100) according to claim 1,
comprising an interface that is adapted to detachably connect at least a part of the components of the audio data processing device (100) to a docking station so as to supply the audio data processing device (100) with energy and/or with audio data and/or to perform the synchronization.

23. The audio data processing device (100) according to claim 1,
wherein the first audio data storage unit (101) is adapted to store audio data related to multiple audio channels, and wherein the first processor unit (102) is adapted to select the first audio data among the multiple audio channels for reproduction by the first audio reproduction unit (103).

24. The audio data processing device (100) according to claim 1,
wherein the second audio data storage unit (104) is adapted to store audio data related to multiple audio channels, and wherein the second processor unit (105) is adapted to select the second audio data among the multiple audio channels for reproduction by the second audio reproduction unit (106).

25. The audio data processing device (100) according to claim 1,
wherein the first processor unit (102) is adapted to process the first audio data based on a Head Related Transfer Function filtering.

26. The audio data processing device (100) according to claim 1,
wherein the second processor unit (105) is adapted to process the second audio data based on a Head Related Transfer Function filtering.

27. The audio data processing device (700) according to claim 1,
comprising a head rotation detection unit (701) adapted to detect a motion of the head of a human being utilizing the audio data processing device (700) and adapted to control the first processor unit (102) and/or the second processor unit (105) based on head rotation information detected by the head rotation detection unit (701).

28. The audio data processing device (100) according to claim 1,
realized as at least one of the group consisting of a portable audio player, a portable video player, a head mounted display, a mobile phone comprising earphones or headphones, a medical communication system, a body-worn device, a DVD player, a CD player, a harddisk-based media player, an internet radio device, a public entertainment device, an MP3 player, headphones, earphones, and a hearing aid device.

29. A method of processing audio data,
the method comprising:
processing, by means of a first processor unit (102), first audio data representing a first audio signal and stored in a first audio data storage unit (101) so that the first audio data is reproducible by a first audio reproduction unit (103);
processing, by means of a second processor unit (105), second audio data representing a second audio signal and stored in a second audio data storage unit (104) so that the second audio data is reproducible by a second audio reproduction unit (106);
time synchronizing the first processor unit (102) with the second processor unit (105) so that the second audio data is reproducible time synchronized to a reproduction of the first audio data.

30. A program element, which, when being executed by a processor, is adapted to control or carry out a method of processing audio data, the method comprising:
processing, by means of a first processor unit (102), first audio data representing a first audio signal and stored in a first audio data storage unit (101) so that the first audio data is reproducible by a first audio reproduction unit (103);
processing, by means of a second processor unit (105), second audio data representing a second audio signal and stored in a second audio data storage unit (104) so that the second audio data is reproducible by a second audio reproduction unit (106);
time synchronizing the first processor unit (102) with the second processor unit (105) so that the second audio data is reproducible time synchronized to a reproduction of the first audio data.

31. A computer-readable medium, in which a computer program is stored which, when being executed by a processor, is adapted to control or carry out a method of processing audio data, the method comprising:
processing, by means of a first processor unit (102), first audio data representing a first audio signal and stored in a first audio data storage unit (101) so that the first audio data is reproducible by a first audio reproduction unit (103);
processing, by means of a second processor unit (105), second audio data representing a second audio signal and stored in a second audio data storage unit (104) so that the second audio data is reproducible by a second audio reproduction unit (106);
time synchronizing the first processor unit (102) with the second processor unit (105) so that the second audio data is reproducible time synchronized to a reproduction of the first audio data.
